(19) United States
(12) Patent Application Publication
(10) Pub. No.: US 2026/0045787 A1
(43) Pub. Date: Feb. 12, 2026

(54) TRANSIENT VOLTAGE SUPPRESSOR AND PRODUCTION METHOD

(71) Applicant: PANSTAR SEMICONDUCTOR CO., LTD., Hsinchu (TW)

(72) Inventor: I-Hua LIN, Hsinchu (TW)

(21) Appl. No.: 19/297,076

(22) Filed: Aug. 12, 2025

(30) Foreign Application Priority Data
Aug. 12, 2024 (TW) 113130144

(51) Int. Cl. H02H 9/04; H02H 9/00

(52) U.S. Cl. CPC H02H 9/04; H02H 9/005

(57) ABSTRACT

The present invention provides a transient voltage suppressor and production method which includes: a first transient voltage suppression unit disposed on a first substrate area and having a first outbound end and a first connection end; a second transient voltage suppression unit disposed on a second substrate area and having a second outbound end and a second connection end; and a connection path is at least partially not disposed on the first substrate area or the second substrate area and configured to electrically connect the first connection end and the second connection end.

### CROSS-REFERENCE TO RELATED APPLICATION

This application claims the priority benefit of Taiwan application serial no. 113130144 filed on Aug. 12, 2024. The entirety of the above-mentioned patent applications is hereby incorporated by reference herein and made a part of this specification.

### FIELD

The present invention relates to the field of circuit protection, and in particular to a transient voltage suppressor and a production method thereof.

### BACKGROUND

Excessive or instantaneous voltage changes in integrated circuits can damage the device. Typical transient voltages may occur during normal operation of the power supply, AC line conversion, and power surges, and include transient voltages generated by electrostatic discharge (ESD). Transient voltage suppressors are used to clamp voltage surges in circuits, limiting the voltage of downstream components and thus avoiding circuit abnormalities.

Conventional transient voltage suppressors are classified into two types: unidirectional and bidirectional. Bidirectional transient voltage suppressors can function when faced with transient voltages of either positive or negative polarity. However, the production of bidirectional transient voltage suppressors requires an additional epitaxy process, deep trench process, metal 2 process and/or via process to avoid parasitic components. Therefore, the cost difference and production difficulty of bidirectional transient voltage suppressors are obvious compared to unidirectional transient voltage suppressors.

In addition, due to its circuit structure, a unidirectional transient voltage suppressor has a higher overall component capacitance than a bidirectional transient voltage suppressor. It is more difficult to apply unidirectional transient voltage suppressors for transient voltage protection in high-frequency (e.g., communications) circuit devices.

Therefore, it is necessary to create a transient voltage suppressor with lower cost and lower overall component capacitance which can also achieve bidirectional voltage regulation.

### SUMMARY

One of the purposes of the present invention is to reduce the overall component capacitance of a transient voltage suppressor.

One of the purposes of the present invention is to reduce the production cost and difficulty of a transient voltage suppressor.

An embodiment of the present invention provides a transient voltage suppressor, comprising: a first transient voltage suppression unit disposed on a first substrate area and having a first outbound end and a first connection end; a second transient voltage suppression unit disposed on a second substrate area and having a second outbound end and a second connection end; and a connection path is at least partially not disposed on the first substrate area or the second substrate area and configured to electrically connect the first connection end and the second connection end.

The transient voltage suppressor according to each embodiment of the present invention can achieve the effect of bidirectional current discharge under different electrical connection conditions, and the two sets of transient voltage suppression units connected in series can also reduce the component capacitance, that is, the component function of the present invention is exactly the same as that of a traditional bidirectional transient voltage suppressor, but the production cost of the present invention is lower.

### BRIEF DESCRIPTION OF THE DRAWINGS

FIG. 1 is a schematic diagram of a transient voltage suppressor of the present invention.

FIG. 2 is a schematic diagram of a transient voltage suppressor according to the present invention added to a packaging frame.

FIG. 3 is a schematic diagram of the electrical connection between the transient voltage suppressor and the packaging frame of the present invention.

FIGS. 4A-4B are diagrams showing an embodiment of a transient voltage suppressor according to the present invention.

FIG. 4C is a schematic diagram of a current path of an embodiment of a transient voltage suppressor according to the present invention when facing a forward bias.

FIG. 4D is a schematic diagram of a current path of an embodiment of a transient voltage suppressor according to the present invention when facing a reverse bias.

FIGS. 4E-4F are diagrams showing an embodiment of a transient voltage suppressor according to the present invention.

FIG. 4G is a schematic diagram of a current path of an embodiment of a transient voltage suppressor according to the present invention when facing a forward bias.

FIG. 4H is a schematic diagram of a current path of an embodiment of a transient voltage suppressor according to the present invention when facing a reverse bias.

FIGS. 5A-5B are diagrams showing an embodiment of a transient voltage suppressor according to the present invention.

FIG. 5C is a schematic diagram of a current path of an embodiment of a transient voltage suppressor according to the present invention when facing a forward bias.

FIG. 5D is a schematic diagram of a current path of an embodiment of a transient voltage suppressor according to the present invention when facing a reverse bias.

FIG. 6 is an embodiment of the transient voltage suppressor of the present invention with a scribe line added.

FIG. 7A is an embodiment of a transient voltage suppressor according to the present invention.

FIG. 7B is a schematic diagram of a current path of an embodiment of a transient voltage suppressor according to the present invention when facing a forward bias.

FIG. 7C is a schematic diagram of a current path of an embodiment of a transient voltage suppressor according to the present invention when facing a reverse bias.

FIG. 8A is an embodiment of a transient voltage suppressor according to the present invention.

FIG. 8B is a schematic diagram of a current path of an embodiment of a transient voltage suppressor according to the present invention when facing a forward bias.

FIG. 8C is a schematic diagram of a current path of an embodiment of a transient voltage suppressor according to the present invention when facing a reverse bias.

FIG. 9 is a flow chart of a method for producing a transient voltage suppressor according to the present invention.

FIGS. 10A-10C are schematic diagrams of a method for producing a transient voltage suppressor according to the present invention.

FIG. 11 is a schematic diagram of an internal structure process of producing a transient voltage suppressor of the present invention.

FIG. 12 is a schematic diagram of a connection path when producing a transient voltage suppressor of the present invention.

FIG. 13 is a schematic diagram showing another connection path when producing a transient voltage suppressor of the present invention.

FIG. 14 is a schematic diagram showing another connection path when producing a transient voltage suppressor of the present invention.

### DETAILED DESCRIPTION

Various embodiments will be described below, and those of ordinary skill in the art can easily understand the spirits and principles of the present disclosure referring to this specification accompanied by the drawings. However, although some particular embodiments will be specifically illustrated herein, these embodiments are only exemplary, and are not to be regarded as limiting or exhaustive in all respects. Therefore, for those of ordinary skill in the art, various changes and modifications to the present disclosure should be obvious and can be easily achieved without departing from the spirits and principles of the present disclosure.

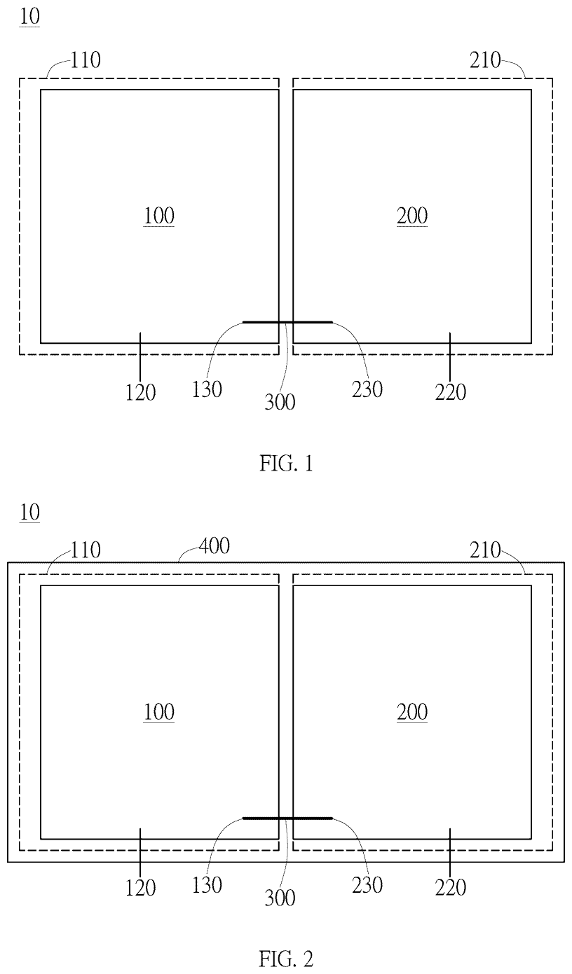

Referring to FIG. 1, FIG. 1 is a schematic diagram of a transient voltage suppressor 10 of the present invention, comprising: a first transient voltage suppression unit 100, a second transient voltage suppression unit 200 and connection path 300. The first transient voltage suppression unit 100 is disposed on a first substrate area 110 and has a first outbound end 120 and a first connection end 130. The first outbound end 120 serves as an input or output current port when facing a transient voltage. The first connection end 130 is used as a port for connecting to other transient voltage suppression units (e.g. the second transient voltage suppression unit 200) or a packaging frame (not shown in FIG. 1). The second transient voltage suppression unit 200 is disposed on a second substrate area 210 and has a second outbound end 220 and a second connection end 230. The second outbound end 220 serves as an input or output current port when facing a transient voltage. The second connection end 230 is used as a port for connecting to other transient voltage suppression units (e.g., the first transient voltage suppression unit 100) or a packaging frame. At least a portion of the connection path 300 is not disposed on the first substrate area 110 or the second substrate area 210 and is used to electrically connect the first connection end 130 and the second connection end 230. Specifically, the first substrate area 110 and the second substrate area 210 may be any areas on the substrate. The substrate disposing the first substrate area 110 and the second substrate area 210 may be a P-type or N-type conductive type.

When the transient voltage suppressor 10 faces a transient voltage, the first transient voltage suppression unit 100 and the second transient voltage suppression unit 200 correspond to transient voltages of different phases. For example, when a transient voltage enters the transient voltage suppressor 10 from the first outbound end 120, the first transient voltage suppression unit 100 suppresses the transient voltage, and the second transient voltage suppression unit 200 turns on. When a transient voltage enters the transient voltage suppressor 10 from the second outbound end 220, the first transient voltage suppression unit 100 turns on, and the second transient voltage suppression unit 200 suppresses the transient voltage. In other words, the transient voltage may enter from one of the first outbound end 120 and the second outbound end 220 (e.g., the first outbound end 120), pass through the connection path 300 between the first connection end 130 and the second connection end 230, and then leave from the other of the first outbound end 120 and the second outbound end 220 (e.g., the second outbound end 220). After the first transient voltage suppression unit 100 and the second transient voltage suppression unit 200 are electrically connected via the connection path 300, they can respectively correspond to transient voltages of different phases. It should be noted that the present invention is not limited to the number of transient voltage suppression units. For example, there may be a plurality of transient voltage suppression units corresponding to transient voltages of different phases, but is not limited thereto.

The connection path 300 can be any means of electrical connection. The connection path 300 is at least partially not disposed on the first substrate area 110 or the second substrate area 210. In other words, the first transient voltage suppression unit 100 and the second transient voltage suppression unit 200 do not directly form a complete connection path on the substrate to electrically connect the first connection end 130 and the second connection end 230. In a specific embodiment, the connection path 300 is a conductor line disposed through a metal bonding process, but is not limited thereto. The connection path 300 prevents the first substrate area 110 and the second substrate area 210 from being directly connected on the substrate. Therefore, the first substrate area 110 and the second substrate area 210 will not interact with each other. Furthermore, the first transient voltage suppression unit 100 and the second transient voltage suppression unit 200 do not require the additional process required by the bidirectional transient voltage suppressor in the prior art. This can reduce component capacitance and production difficulty and cost.

In one embodiment, referring to FIG. 2, FIG. 2 is a schematic diagram of a transient voltage suppressor 10 according to the present invention added to a packaging frame 400. Specifically, the first transient voltage suppression unit 100 and the second transient voltage suppression unit 200 are disposed in the accommodation space disposed by the packaging frame 400. The packaging frame 400 isolates the first transient voltage suppression unit 100 and the second transient voltage suppression unit 200 from the outside, thereby providing the transient voltage suppressor 10 structural integrity. This design maintains the transient voltage suppression function while reducing external influences.

In an embodiment of a packaging frame, referring to FIG. 3, FIG. 3 is a schematic diagram illustrating the electrical connection between the first transient voltage suppression unit 100 and the second transient voltage suppression unit 200 through the packaging frame 400 of the present invention. Specifically, the packaging frame 400 is made of a conductive material, and the first connection end 130 and the second connection end 230 are respectively electrically connected to the packaging frame 400. In other words, the connection path 300 electrically connecting the first connection end 130 and the second connection end 230 is disposed on the packaging frame 400. In this embodiment, when facing a transient voltage, transient current will enter from one of the first outbound end 120 and the second outbound end 220, pass through the connection path 300 disposed on the packaging frame 400, and then leave from the other of the first outbound end 120 and the second outbound end 220. In this path, the transient voltage will be suppressed by one of the first transient voltage suppression unit 100 and the second transient voltage suppression unit 200, and the other one is turned on. By providing the connection path 300 through the package frame 400, the transient voltage suppressor 10 can meet different layout requirements. In another aspect, the package frame 400 can allow a larger transient current and achieve the purpose of reducing the overall component capacitance and production cost.

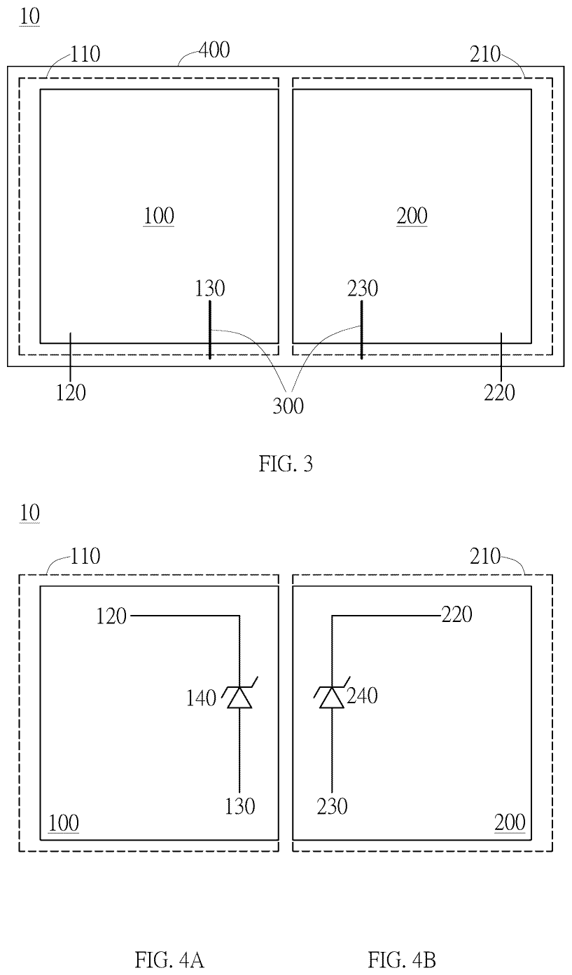

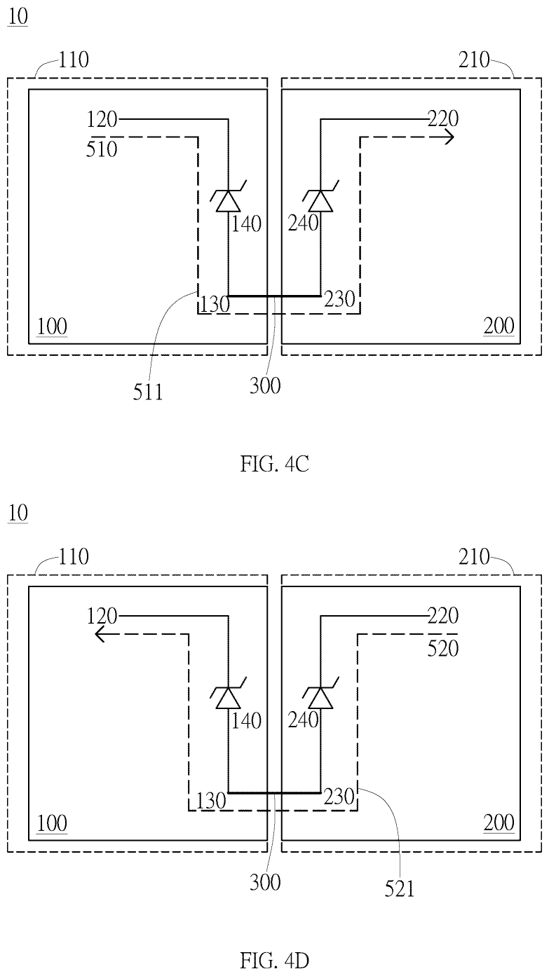

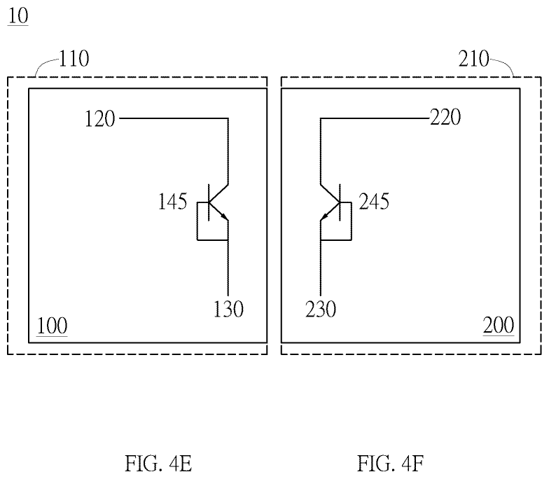

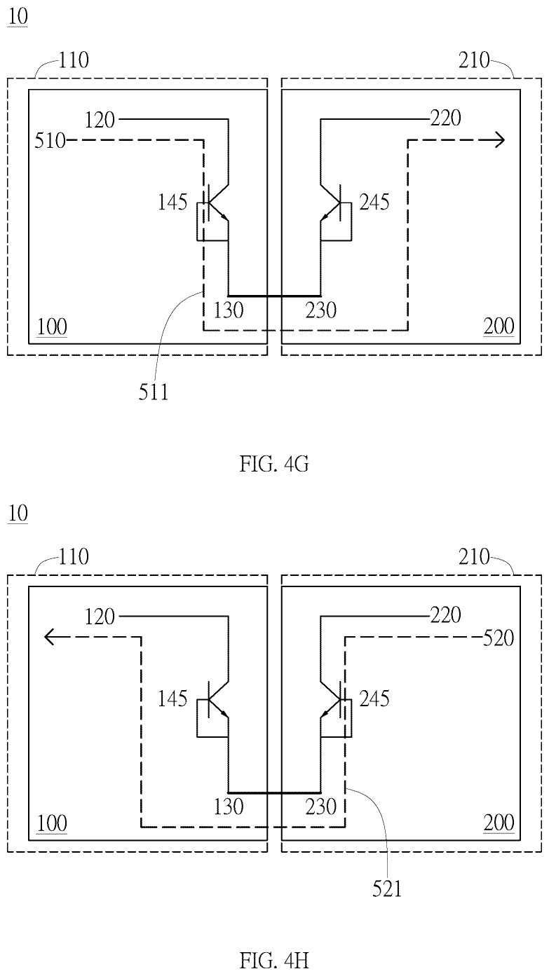

In another embodiment, referring to FIG. 4A and FIG. 4B, FIG. 4A and FIG. 4B are another schematic diagrams of the transient voltage suppressor 10 of the present invention. In FIG. 4A, the first transient voltage suppression unit 100 includes a first Zener diode 140. The first Zener diode 140 utilizes the Zener effect of the diode under reverse bias operation to stabilize the voltage. In this embodiment, the first outbound end 120 of the first transient voltage suppression unit 100 is selected from one of the anode and the cathode of the first Zener diode 140, and the first connection end 130 is selected from the other. It should be noted that the present invention is not limited to the first transient voltage suppression unit 100 and the second transient voltage suppression unit 200 having corresponding structures. For an embodiment where the first transient voltage suppression unit 100 and the second transient voltage suppression unit 200 have corresponding structures, please refer to FIG. 4B. The second transient voltage suppression unit 200 includes a second Zener diode 240, wherein the second outbound end 220 is selected from one of the anode and the cathode of the Zener diode, and the second connection end 230 is selected from the other. Specifically, when the first connection end 130 is selected from the anode of the first Zener diode 140, the second connection end 230 should be selected from the anode of the second Zener diode 240. Thus, the first Zener diode 140 and the second Zener diode 240 can respectively respond to transient voltages in different directions.

In this embodiment, please refer to FIG. 4C and FIG. 4D for the specific transient current path. As shown in FIG. 4C, the connection path 300 electrically connects the anode of the first Zener diode 140 and the anode of the second Zener diode 240 to each other. When facing a first direction transient voltage 510 from the cathode of the first Zener diode 140 (i.e., the first outbound end 120), the first direction transient voltage 510 generates a first direction current 511. The first direction current 511 flows to the first Zener diode 140, causing the first Zener diode 140 to undergo Zener breakdown due to the reverse bias and then achieve a voltage regulation function. The first direction current 511 then flows from the first connection end 130 to the connection path 300, and then flows through the connection path 300 to the second Zener diode 240 via the second connection end 230, and is conducted out from the second outbound end 220.

As shown in FIG. 4D, the connection path 300 electrically connects the anode of the first Zener diode 140 and the anode of the second Zener diode 240 to each other. When facing a second direction transient voltage 520 from the cathode of the second Zener diode 240 (i.e., the second outbound end 220), the second direction transient voltage 520 generates a second direction current 521. The second direction current 521 flows to the second Zener diode 240, causing the second Zener diode 240 to undergo Zener breakdown due to the reverse bias and then achieve a voltage regulation function. The second direction current 521 then flows from the second connection end 230 to the connection path 300, and then flows through the connection path 300 to the first Zener diode 140 via the first connection end 130, and is conducted out from the first outbound end 120.

In another embodiment, referring to FIG. 4E and FIG. 4F, FIG. 4E and FIG. 4F are another schematic diagram of the transient voltage suppressor 10 of the present invention. In FIG. 4E, the first transient voltage suppression unit 100 includes a first bipolar junction transistor 145. In this embodiment, the first bipolar junction transistor is an NPN structure. By connecting the base and the emitter of the first bipolar junction transistor 145, the first bipolar junction transistor 145 is equivalent to a Zener diode structure and also has a voltage regulation function. In this embodiment, the first outbound end 120 of the first transient voltage suppression unit 100 is selected from one of the collector and the emitter of a bipolar junction transistor, and the first connection end 130 is selected from the other. should be noted that the present invention is not limited to the first transient voltage suppression unit 100 and the second transient voltage suppression unit 200 having corresponding structures, and the bipolar junction transistor can be an NPN or PNP structure. For an embodiment where the first transient voltage suppression unit 100 and the second transient voltage suppression unit 200 have corresponding structures, please refer to FIG. 4F. The second outbound end 220 of the second transient voltage suppression unit 200 is selected from one of the collector and the emitter of a bipolar junction transistor, and the second connection end 230 is selected from the other. Specifically, when the first connection end 130 is selected from the emitter of the first bipolar junction transistor 145, the second connection end 230 should be selected from the emitter of the second bipolar junction transistor 245. Thus, the first bipolar junction transistor 145 and the second bipolar junction transistor 245 can respectively respond to transient voltages in different directions.

In this embodiment, please refer to FIG. 4G and FIG. 4H for the specific transient current path. As shown in FIG. 4G, the connection path 300 electrically connects the emitter of the first bipolar junction diode 145 and the emitter of the second bipolar junction diode 245 to each other. When facing a first direction transient voltage 510 from the collector of the first bipolar junction diode 145 (i.e., the first outbound end 120), the first direction transient voltage 510 generates a first direction current 511. The first direction current 511 flows to the first bipolar junction diode 145 so that the collector and base of the first bipolar junction diode 145 can achieve a voltage regulation function due to the reverse bias voltage close to Zener breakdown. The first direction current 511 then flows from the first connection end 130 to the connection path 300, and then flows through the connection path 300 to the second bipolar junction diode 245 via the second connection end 230, and is conducted out from the second outbound end 220.

As shown in FIG. 4H, the connection path 300 electrically connects the emitter of the first bipolar junction diode 145 and the emitter of the second bipolar junction diode 245 to each other. When facing a second direction transient voltage 520 from the collector of the second bipolar junction diode 245 (i.e., the second outbound end 220), the second direction transient voltage 520 generates a second direction current 521. The second direction current 521 flows to the second bipolar junction diode 245 so that the collector and base of the second bipolar junction diode 245 can achieve a voltage regulation function due to the reverse bias voltage close to Zener breakdown. The second direction current 521 then flows from the second connection end 230 to the connection path 300, and then flows through the connection path 300 to the first bipolar junction diode 145 via the first connection end 130, and is conducted out from the first outbound end 120.

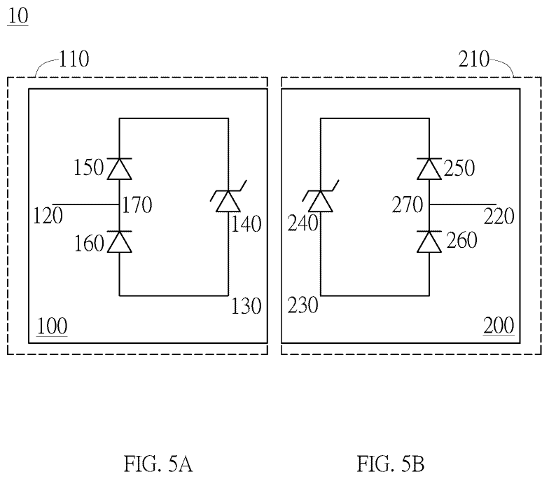

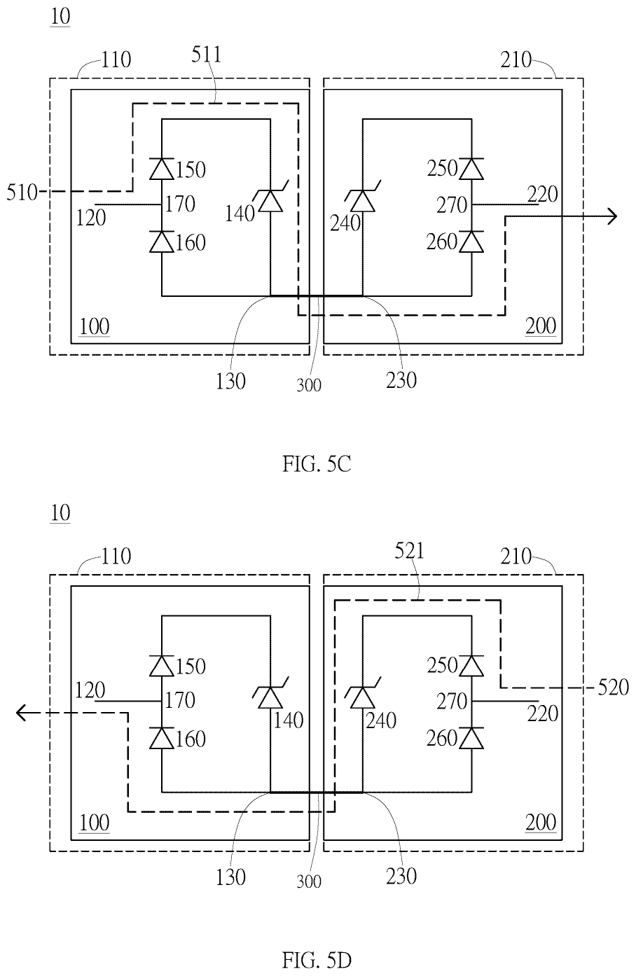

In another embodiment, referring to FIG. 5A and FIG. 5B, FIG. 5A and FIG. 5B are another schematic diagrams of the transient voltage suppressor 10 of the present invention. In FIG. 5A, the first transient voltage suppression unit 100 includes a first Zener diode 140, a first diode 150, and a second diode 160. The cathode of the first diode 150 is electrically connected to the cathode of the first Zener diode 140, and the anode of the second diode 160 is electrically connected to the anode of the first Zener diode 140. The first diode connection end 170 is electrically connected to the cathode of the second diode 160 and the anode of the first diode 150. The first outbound end 120 is selected from one of the anode of the Zener diode and the first diode connection end 170, and the first connection end 130 is selected from the other. It should be noted that the present invention is not limited to the first transient voltage suppression unit 100 and the second transient voltage suppression unit 200 having corresponding structures. For an embodiment where the first transient voltage suppression unit 100 and the second transient voltage suppression unit 200 have corresponding structures, please refer to FIG. 5B. The structure of the second transient voltage suppression unit 200 may be the same as that of the first transient voltage suppression unit 100. In this case, the second transient voltage suppression unit 200 includes a second Zener diode 240, a third diode 250, and a fourth diode 260. The cathode of the third diode 250 is electrically connected to the cathode of the second Zener diode 240 and the anode of the fourth diode 260 is electrically connected to the anode of the second Zener diode 240. The second diode connection end 270 is electrically connected to the cathode of the fourth diode 260 and the anode of the third diode 250. The second outbound end 220 is selected from one of the anode of the second Zener diode 240 and the second diode connection end 270, and the second connection end 230 is selected from the other. Specifically, when the first connection end 130 is selected from the anode of the first Zener diode 140, the second connection end 230 should be selected from the anode of the second Zener diode 240. Thus, the first Zener diode 140 and the second Zener diode 240 can respectively respond to transient voltages in different directions.

In this embodiment, please refer to FIG. 5C and FIG. 5D for the specific transient current path. As shown in FIG. 5C, the connection path 300 electrically connects the anode of the first Zener diode 140 and the anode of the second Zener diode 240 to each other. When facing a first direction transient voltage 510 from the first diode connection end 170 (i.e., the first outbound end 120), the first direction transient voltage 510 generates a first direction current 511. The first direction current 511 is received by the first outbound end 120 and flows to the first diode 150. After being rectified by the first diode 150, the first direction current 511 flows from the first diode 150 to the first Zener diode 140, causing the first Zener diode 140 to undergo Zener breakdown due to the reverse bias and then achieve a voltage regulation function. The first direction current 511 then flows from the first connection end 130 to the connection path 300, and then flows through the connection path 300 to the fourth diode 260 via the second connection end 230. After being rectified by the fourth diode 260, it is conducted out from the second outbound end 220.

As shown in FIG. 5D, the connection path 300 electrically connects the anode of the first Zener diode 140 and the anode of the second Zener diode 240 to each other. When facing a second direction transient voltage 520 from the second diode connection end 270 (i.e., the second outbound end 220), the second direction transient voltage 520 generates a second direction current 521. The second direction current 521 is received by the second outbound end 220 and flows to the third diode 250. After being rectified by the third diode 250, the second direction current 521 flows from the third diode 250 to the second Zener diode 240, causing the second Zener diode 240 to undergo Zener breakdown due to the reverse bias and then achieve a voltage regulation function. The second direction current 521 then flows from the second connection end 230 to the connection path 300, and then flows through the connection path 300 to the second diode 160 via the first connection end 130. After being rectified by the second diode 160, it is conducted out from the first outbound end 120.

Referring to FIG. 6, FIG. 6 is a schematic diagram of a transient voltage suppressor 10 and a scribe line 600 of the present invention. There is a scribe line 600 between the first substrate area 110 and the second substrate area 210, and the scribe line 600 blocks the formation of a parasitic element between the first transient voltage suppression unit 100 and the second transient voltage suppression unit 200. The scribe line 600 may be less than 20 um during the process. In one embodiment, the scribe line 600 is preferably provided with a solid molding material 610 to help the scribe line 600 prevent parasitic elements from being disposed between the first transient voltage suppression unit 100 and the second transient voltage suppression unit 200.

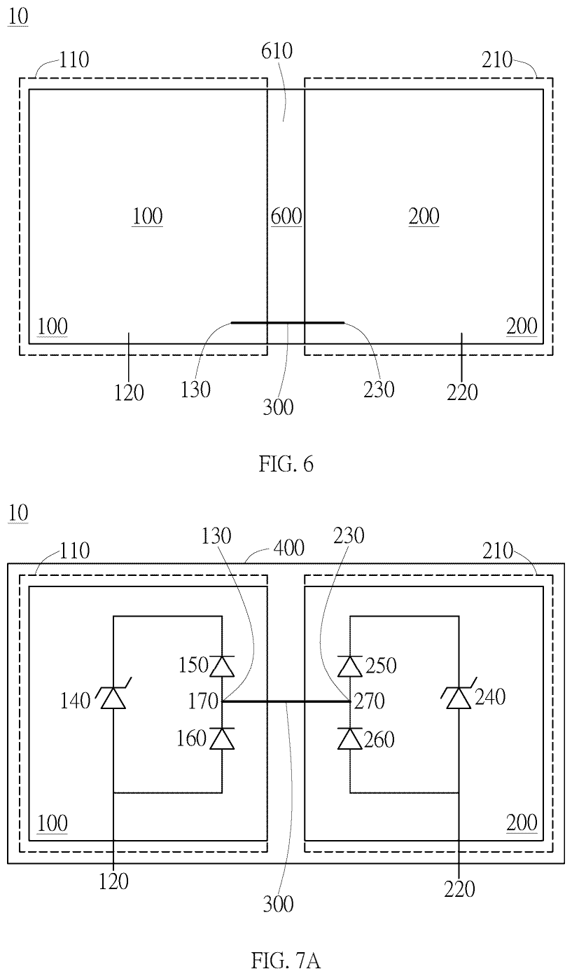

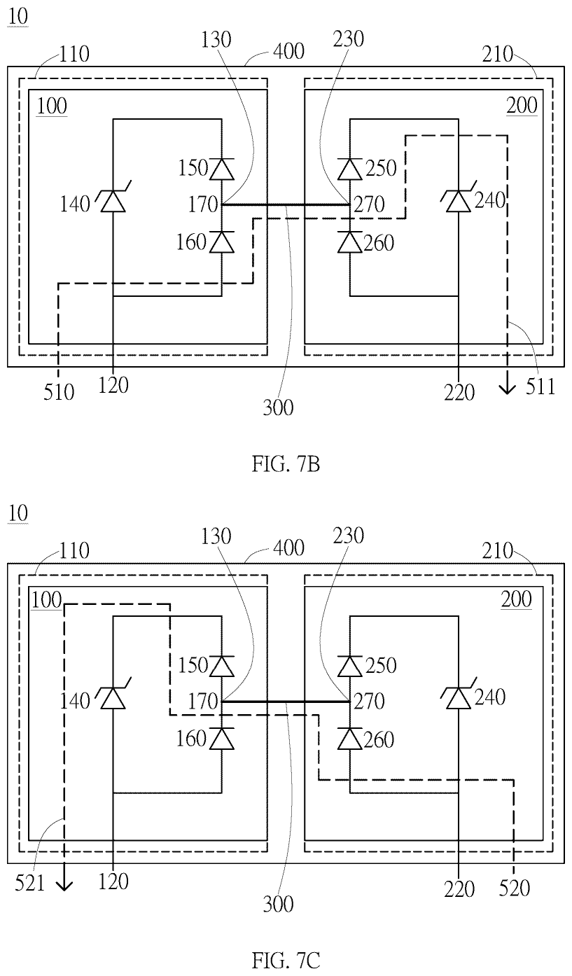

Referring to FIG. 7A, FIG. 7A is a schematic diagram of another embodiment of the transient voltage suppressor 10 of the present invention. The first transient voltage suppression unit 100 includes a first Zener diode 140, a first diode 150 and a second diode 160. The anode of the first Zener diode 140 serves as the first outbound end 120 of the first transient voltage suppression unit 100. The cathode of the first diode 150 is electrically connected to the cathode of the first Zener diode 140. The anode of the second diode 160 is electrically connected to the first outbound end 120. The anode of the first diode 150 is electrically connected to the cathode of the second diode 160 to serve as the first diode connection end 170. The first diode connection end 170 serves as the first connection end 130. The second transient voltage suppression unit 200 includes a second Zener diode 240, a third diode 250 and a fourth diode 260. The anode of the second Zener diode 240 serves as the second outbound end 220 of the second transient voltage suppression unit 200. The cathode of the third diode 250 is electrically connected to the cathode of the second Zener diode 240. The anode of the fourth diode 260 is electrically connected to the second outbound end 220. The anode of the third diode 250 is electrically connected to the cathode of the fourth diode 260 to serve as the second diode connection end 270. The second diode connection end 270 serves as the second connection end 230. The transient voltage suppression 10 further includes a packaging frame 400, wherein the first transient voltage suppression unit 100 and the second transient voltage suppression unit 200 are disposed in an accommodation space disposed by the packaging frame 400. The first connection end 130 is electrically connected to the connection path 300 of the second connection end 230, and the connection path 300 is not located on the first substrate area 110 or the second substrate area 210.

In this embodiment, please refer to FIG. 7B and FIG. 7C for the specific transient current path. As shown in FIG. 7B, the connection path 300 electrically connects the first diode connection end 170 and the second diode connection end 270 to each other. When facing a first direction transient voltage 510 from the first Zener diode 140 (i.e., the first outbound end 120), the first direction transient voltage 510 generates a first direction current 511. The first direction current 511 is received by the first outbound end 120 and flows to the second diode 160. After being rectified by the second diode 160, it flows from the first connection end 130 to the connection path 300. After passing through the connection path 300, the current flows to the third diode 250 via the second connection end 230. After being rectified by the third diode 250, the current flows to the second Zener diode 240, causing the second Zener diode 240 to undergo Zener breakdown due to the reverse bias and then achieve a voltage regulation function. The first direction current 511 is then conducted out from the second outbound end 220.

As shown in FIG. 7C, the connection path 300 electrically connects the first diode connection end 170 and the second diode connection end 270 to each other. When facing a second direction transient voltage 520 from the second Zener diode 240 (i.e., the second outbound end 220), the second direction transient voltage 520 generates a second direction current 521. The second direction current 521 is received by the second outbound end 220 and flows to the fourth diode 260. After being rectified by the fourth diode 260, it flows from the second connection end 230 to the connection path 300. After passing through the connection path 300, the current flows to the first diode 150 via the first connection end 130. After being rectified by the first diode 150, the current flows to the first Zener diode 140, causing the first Zener diode 140 to undergo Zener breakdown due to the reverse bias and then achieve a voltage regulation function. The second direction current 521 is then conducted out from the first outbound end 120.

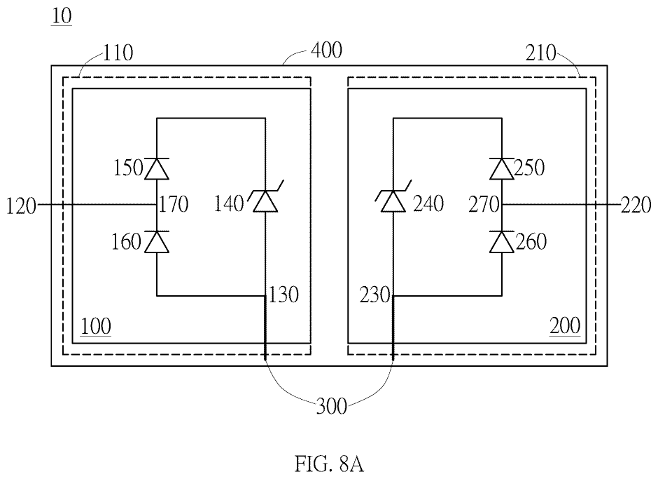

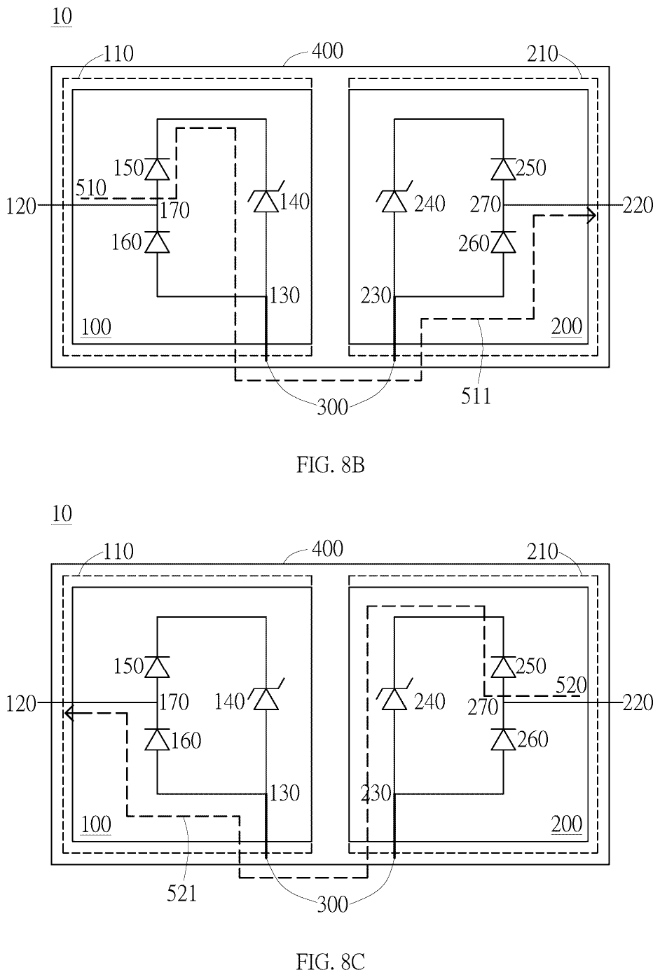

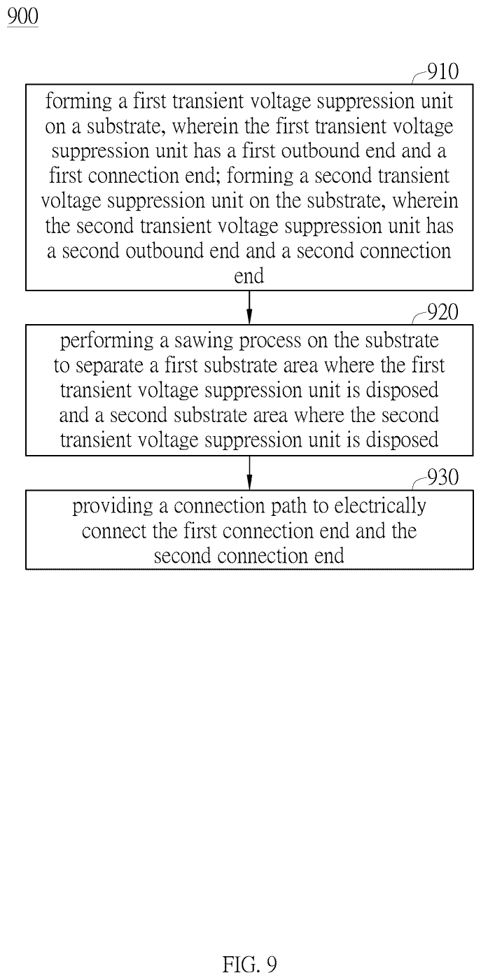

Referring to FIG. 8A, FIG. 8A is a schematic diagram of another embodiment of the transient voltage suppressor 10 of the present invention. The first transient voltage suppression unit 100 includes a first Zener diode 140, a first diode 150 and a second diode 160. The anode of the first Zener diode 140 serves as the first connection end 130 of the first transient voltage suppression unit 100. The cathode of the first diode 150 is electrically connected to the cathode of the first Zener diode 140. The anode of the second diode 160 is electrically connected to the first connection end 130. The anode of the first diode 150 is electrically connected to the cathode of the second diode 160 to serve as the first diode connection end 170. The first diode connection end 170 serves as the first outbound end 120. The second transient voltage suppression unit 200 includes a second Zener diode 240, a third diode 250 and a fourth diode 260. The anode of the second Zener diode 240 serves as the second connection end 230 of the second transient voltage suppression unit 200. The cathode of the third diode 250 is electrically connected to the cathode of the second Zener diode 240. The anode of the fourth diode 260 is electrically connected to the second connection end 230. The anode of the third diode 250 is electrically connected to the cathode of the fourth diode 260 to serve as the second diode connection end 270. The second diode connection end 270 serves as the second outbound end 220. The transient voltage suppression 10 further includes a packaging frame 400, wherein the first transient voltage suppression unit 100 and the second transient voltage suppression unit 200 are disposed in an accommodation space disposed by the packaging frame 400. The first connection end 130 and the second connection end 230 are respectively electrically connected to the packaging frame 400 to generate a connection path 300. At this time, the packaging frame 400 is a part of the connection path 300, and the connection path 300 is not located on the first substrate area 110 or the second substrate area 210.

In this embodiment, please refer to FIG. 8B and FIG. 8C for the specific transient current path. As shown in FIG. 5C, the connection path 300 electrically connects the anode of the first Zener diode 140 and the anode of the second Zener diode 240 to each other. When facing a first direction transient voltage 510 from the first diode connection end 170 (i.e., the first outbound end 120). The first direction transient voltage 510 generates a first direction current 511, the first direction current 511 is received by the first outbound end 120 and flows to the first diode 150. After being rectified by the first diode 150, the first direction current 511 flows from the first diode 150 to the first Zener diode 140, causing the first Zener diode 140 to undergo Zener breakdown due to the reverse bias and then achieve a voltage regulation function. The first direction current 511 then flows from the first connection end 130 to the connection path 300, and then flows through the connection path 300 to the fourth diode 260 via the second connection end 230. After being rectified by the fourth diode 260, it is conducted out from the second outbound end 220.

As shown in FIG. 8C, the connection path 300 electrically connects the anode of the first Zener diode 140 and the anode of the second Zener diode 240 to each other. When facing a second direction transient voltage 520 from the second diode connection end 270 (i.e., the second outbound end 220), the second direction transient voltage 520 generates a second direction current 521. The second direction current 521 is received by the second outbound end 220 and flows to the third diode 250. After being rectified by the third diode 250, the second direction current 521 flows from the third diode 250 to the second Zener diode 240, causing the second Zener diode 240 to undergo Zener breakdown due to the reverse bias and then achieve a voltage regulation function. The second direction current 521 then flows from the second connection end 230 to the connection path 300, and then flows through the connection path 300 to the second diode 160 via the first connection end 130. After being rectified by the second diode 160, it is conducted out from the first outbound end 120.

Through the transient voltage suppressor of each embodiment of the present invention, the effect of bidirectional current discharge can be achieved under different electrical connection conditions, and the two sets of transient voltage suppression units connected in series can also reduce component capacitance, that is, the component function of the present invention is exactly the same as that of a traditional bidirectional transient voltage suppressor, but the production cost of the present invention is lower.

Referring to FIG. 9, FIG. 9 is a flow chart of a method for producing a transient voltage suppressor according to the present invention, comprising: disposing a first transient voltage suppression unit on a substrate, wherein the first transient voltage suppression unit has a first outbound end and a first connection end; disposing a second transient voltage suppression unit on the substrate, wherein the second transient voltage suppression unit has a second outbound end and a second connection end; performing a sawing process on the substrate to separate a first substrate area where the first transient voltage suppression unit is disposed and a second substrate area where the second transient voltage suppression unit is disposed; and providing a connection path to electrically connect the first connection end and the second connection end.

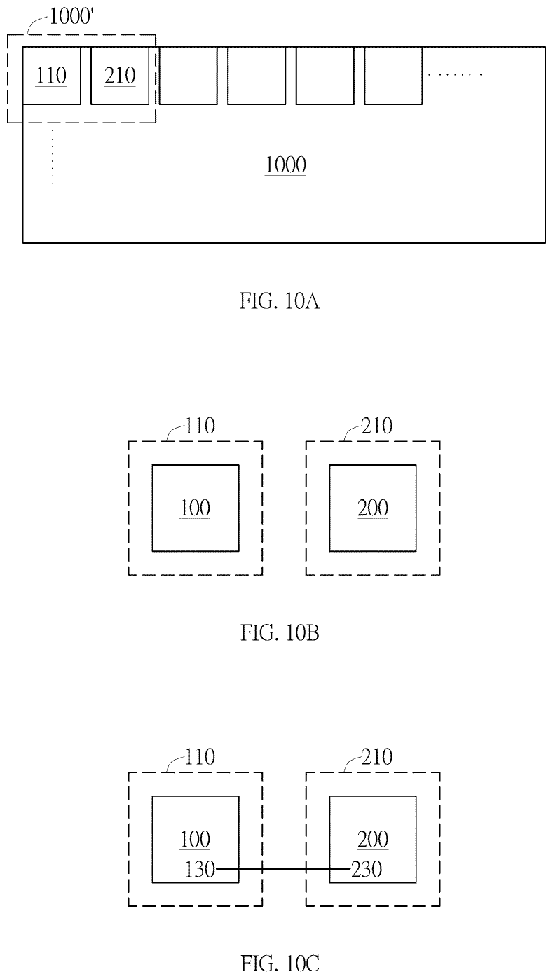

Referring to FIGS. 10A-10C, FIGS. 10A-10C are schematic diagrams of a method for producing a transient voltage suppressor according to the present invention. As shown in FIG. 10A, a first substrate area 110 and a second substrate area 210 are disposed on the substrate 1000. As shown in FIG. 10B, a sawing process is performed on the substrate 1000′ to separate the first transient voltage suppression unit 100 in the first substrate area 110 and the second transient voltage suppression unit 200 in the second substrate area 210. As shown in FIG. 10C, a connection path 300 is provided to electrically connect the first connection end 130 and the second connection end 230.

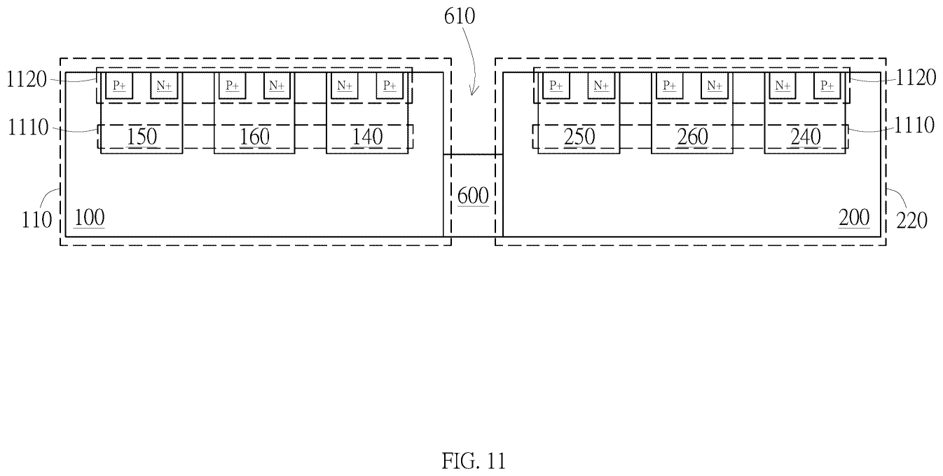

In one embodiment, when disposing the first transient voltage suppression unit 100 and the second transient voltage suppression unit 200, a well process 1110 and a high concentration doping process 1120 are further included to generate the PN junction required by the diode. Furthermore, the well process 1110 and the high concentration doping process 1120 of the method for producing a transient voltage suppressor of the present invention can form a diode or a Zener diode. As shown in FIG. 11, the first transient voltage suppression unit 100 includes a first diode 150, a second diode 160 and a first Zener diode 140, and the second transient voltage suppression unit 200 includes a third diode 250, a fourth diode 260 and a second Zener diode 240.

In one embodiment, a scribe line 600 may be further generated between the first transient voltage suppression unit 100 and the second transient voltage suppression unit 200 during the sawing process. As shown in FIG. 11, the scribe line 600 prevents the formation of parasitic elements between the first transient voltage suppression unit 100 and the second transient voltage suppression unit 200. The scribe line 600 may be smaller than 20 um during the producing process. In this case, a solid molding material 610 is preferably disposed to help the scribe line 600 prevent the formation of parasitic elements between the first transient voltage suppression unit 100 and the second transient voltage suppression unit 200.

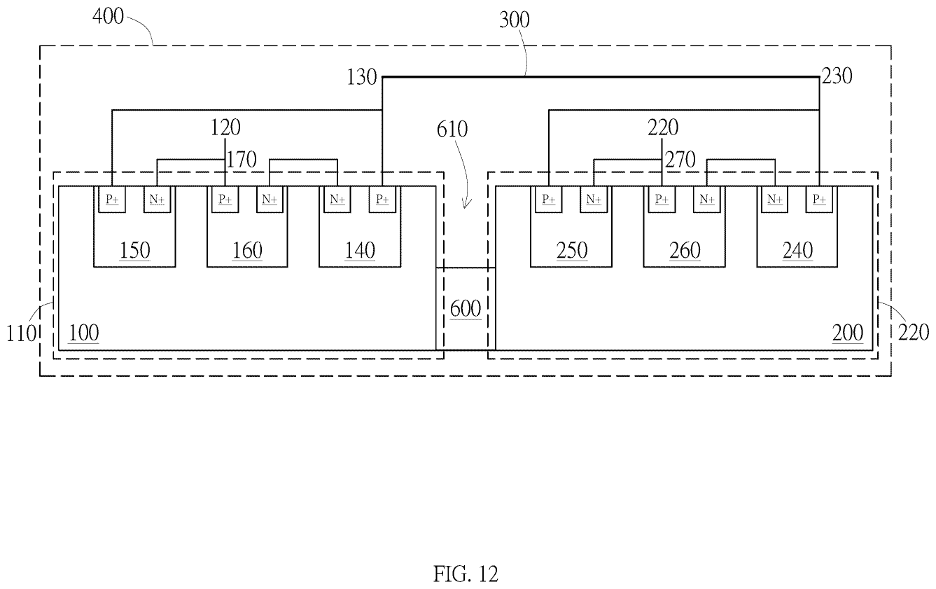

In one embodiment, referring to FIG. 12, FIG. 12 is a schematic diagram of the connection path when producing the transient voltage suppressor of the present invention. In the packaging stage, the first transient voltage suppression unit 100 and the second transient voltage suppression unit 200 are accommodated in the packaging frame 400. In this embodiment, the anode of the first diode 150 is electrically connected to the anode of the first Zener diode 140, and the cathode of the first diode 150 is electrically connected to the anode of the second diode 160, and is defined as the first diode connection end 170. The cathode of the second diode 160 is electrically connected to the cathode of the first Zener diode 140, and the anode of the third diode 250 is electrically connected to the anode of the second Zener diode 240. The cathode of the third diode 250 is electrically connected to the anode of the fourth diode 260 and is defined as the second diode connection end 270. The cathode of the fourth diode 260 is electrically connected to the cathode of the second Zener diode 240. The anode of the first Zener diode 140 is defined as the first connection end 130, the anode of the second Zener diode 240 is defined as the second connection end 230, and the first connection end 130 of the first transient voltage suppression unit 100 and the second connection end 230 of the second transient voltage suppression unit 200 are electrically connected through a connection path 300.

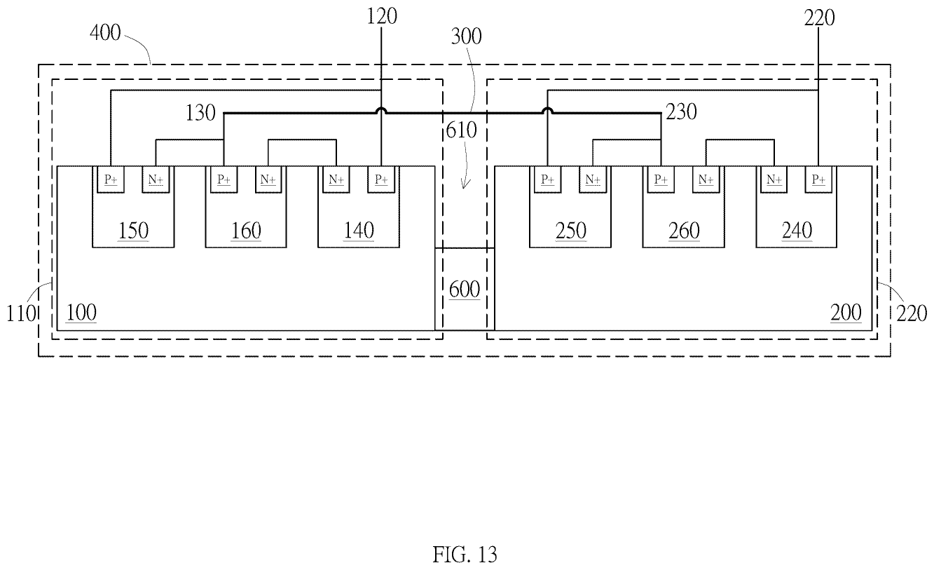

In one embodiment, referring to FIG. 13, FIG. 13 is a schematic diagram showing another connection path when producing the transient voltage suppressor of the present invention. In this embodiment, the first diode connection end 170 is defined as the first connection end 130, and the second diode connection end 270 is defined as the second connection end 230. The anode of the first Zener diode 140 is defined as the first outbound end 120, the anode of the second Zener diode 240 is defined as the second outbound end 220, and the first connection end 130 of the first transient voltage suppression unit 100 and the second connection end 230 of the second transient voltage suppression unit 200 are electrically connected through a connection path 300.

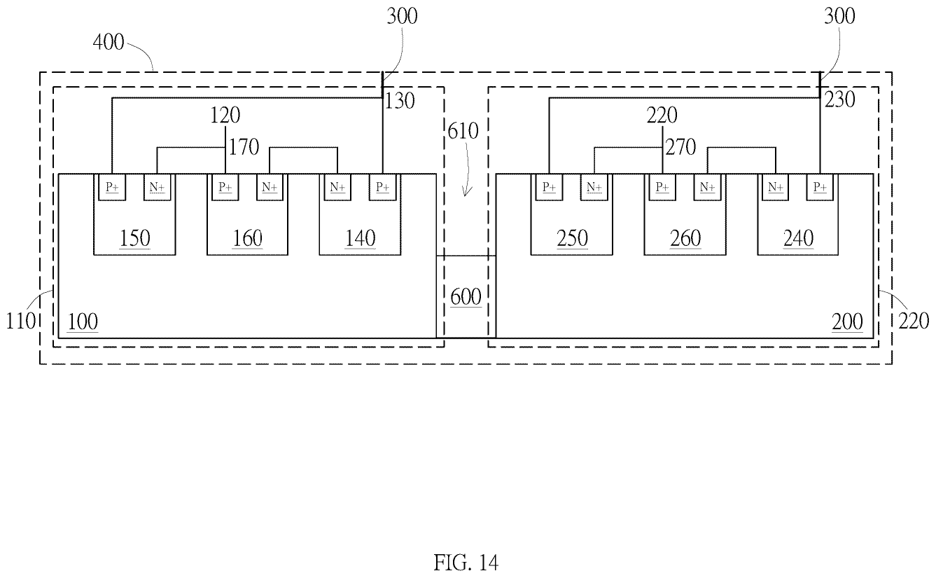

In one embodiment, referring to FIG. 14, FIG. 14 is a schematic diagram showing another connection path when producing the transient voltage suppressor of the present invention. In this embodiment, the first diode connection end 170 is defined as the first outbound end 120, and the second diode connection end 270 is defined as the second outbound end 220. The anode of the first Zener diode 140 is defined as the first connection end 130, and the anode of the second Zener diode 240 is defined as the second connection end 230. At this time, the connection path 300 can be electrically connected to the packaging frame 400 from the first connection end 130 and the second connection end 230 respectively, and the connection path 300 is disposed on the packaging frame 400.

In summary, the transient voltage suppressor according to each embodiment of the present invention can realize the function of bidirectional transient voltage suppression, and can be disposed by electrically connecting two transient voltage suppression units. As described above, the transient voltage suppressor according to each embodiment of the present invention can be applied as a transient voltage suppression component such as a power supply, an AC line converter, an electric shock surge, and an electrostatic discharge, and according to various embodiments of the present invention, the applicable aspects are not limited to the specific examples in this invention.

The above description contains only some preferred embodiments of the present invention. Among them, the proportions and relative proportions of each component or part shown in the drawings may be exaggerated or changed for the purpose of clear display or convenience of explanation, and those with ordinary skill in the art should understand that they are not intended to be specific dimensional limitations. In addition, it should be noted that various changes and modifications can be made to the present invention without departing from the spirit and principles of the present invention. Those of ordinary skill in the art should understand that the present invention is defined by the appended claims, and under the spirit of the present invention, all possible replacements, combinations, modifications, diversions and other changes would not exceed the scope of the present invention defined by the appended claims.

What is claimed is:

1. A transient voltage suppressor, comprising:
a first transient voltage suppression unit disposed on a first substrate area and having a first outbound end and a first connection end;
a second transient voltage suppression unit disposed on a second substrate area and having a second outbound end and a second connection end; and
a connection path at least partially not disposed on the first substrate area and the second substrate area and configured to electrically connect the first connection end and the second connection end.

2. The transient voltage suppressor of claim 1, further comprising a packaging frame, wherein the first transient voltage suppression unit and the second transient voltage suppression unit are disposed in an accommodation space enclosed by the packaging frame.

3. The transient voltage suppressor of claim 2, wherein the packaging frame is made of a conductive material, the first connection end and the second connection end are respectively electrically connected to the packaging frame, and the connection path is disposed on the packaging frame.

4. The transient voltage suppressor of claim 1, wherein the first transient voltage suppression unit includes a Zener diode, the first outbound end is selected from one of an anode and a cathode of the Zener diode, and the first connection end is selected from the other of the anode and the cathode of the Zener diode.

5. The transient voltage suppressor of claim 1, wherein the first transient voltage suppression unit includes a bipolar junction transistor, the first outbound end is selected from one of a collector and an emitter of the bipolar junction transistor, and the first connection end is selected from the other of the collector and the emitter of the bipolar junction transistor.

6. The transient voltage suppressor of claim 5, wherein a base of the bipolar junction transistor is connected to the emitter.

7. The transient voltage suppressor of claim 1, wherein first transient voltage suppression unit includes a Zener diode, a first diode and a second diode;
a cathode of the first diode is electrically connected to a cathode of the Zener diode, and an anode of the second diode is electrically connected to an anode of the Zener diode;
a diode connection end is electrically connected to a cathode of the second diode and an anode of the first diode, the first outbound end is selected from one of the anode of the Zener diode and the diode connection end, and the first connection end is selected from the other of the anode of the Zener diode and the diode connection end.

8. The transient voltage suppressor of claim 1, wherein a scribe line exists between the first substrate area and the second substrate area.

9. The transient voltage suppressor of claim 8, wherein a solid molding material is arranged in the scribe line.

10. The transient voltage suppressor of claim 1, wherein the connection path is disposed on the first connection end and the second connection end through a wire bonding process.

11. A method for manufacturing a transient voltage suppressor, comprising:
disposing a first transient voltage suppression unit on a substrate, wherein the first transient voltage suppression unit has a first outbound end and a first connection end;
disposing a second transient voltage suppression unit on the substrate, wherein the second transient voltage suppression unit has a second outbound end and a second connection end;
performing a sawing process on the substrate to separate a first substrate area with the first transient voltage suppression unit disposed thereon and a second substrate area with the second transient voltage suppression unit disposed thereon; and
providing a connection path to electrically connect the first connection end and the second connection end.

12. The method of claim 11, further comprising after the sawing process, disposing the first substrate area and the second substrate area in an accommodation space disposed by a packaging frame.

13. The method of claim 12, further comprising electrically connecting the first connection end and the second connection end to the packaging frame respectively, wherein the connection path is disposed on the packaging frame.

14. The method of claim 11, further comprising disposing a scribe line between the first transient voltage suppression unit and the second transient voltage suppression unit.

15. The method of claim 14, further comprising filling a solid molding material into the scribe line.
